(19) United States
(12) Patent Application Publication
(10) Pub. No.: US 2026/0205007 A1
(43) Pub. Date: Jul. 16, 2026

(54) COMPACT AND LOW-POWER SUPPLY FAIL-SAFE CIRCUIT

(71) Applicant: TEXAS INSTRUMENTS INCORPORATED, Dallas, TX (US)

(72) Inventors: Prashant Kurrey, Raigarh (IN); Rohan Sinha, Bengaluru (IN)

(21) Appl. No.: 19/016,500

(22) Filed: Jan. 10, 2025

(51) Int. Cl. H02M 1/32; H02M 3/156

(52) U.S. Cl. CPC H02M 1/32; H02M 3/156

(57) ABSTRACT

Disclosed herein is a device including a first voltage rail and a second voltage rail configured to provide a first voltage. A current source component is conductively coupled to the first voltage rail and the second voltage rail and is configured to provide a first current. A voltage translator is conductively coupled to the second voltage rail and the current source component and is configured to invert the first voltage to a second voltage and provide an output signal including the first current and the second voltage.

### FIELD

The present disclosure generally relates integrated circuit devices and, more particularly, but not exclusively, to dual power supply integrated circuit devices.

### BACKGROUND

Dual power supply integrated circuits may use a supply fail-safe circuit to provide an output voltage when both power supply voltages are above a threshold point. The current consumed by the supply fail-safe circuit is dependent on one or both power supplies. This can cause the current consumption of the supply fail-safe circuit to vary across temperature and voltage ranges. Additionally, during power up there is the possibility that the internal signals of the dual supply interfacing circuit are undefined due to the difference in time of each of the power supplies providing the proper voltage, when a supply fail-safe circuit is not used.

### SUMMARY

Disclosed herein is a device including a first voltage rail and a second voltage rail configured to provide a first voltage. A current source component is conductively coupled to the first voltage rail and the second voltage rail, and is configured to provide a first current. A voltage translator is conductively coupled to the second voltage rail and the current source component, and is configured to invert the first voltage to a second voltage and provide an output signal including the first current and the second voltage.

Also disclosed herein is a device including a supply fail-safe component conductively coupled to first, second, and third voltage rails. The supply fail-safe component is configured to provide an output signal based on a voltage of the first voltage rail, and includes a feedback loop conductively coupled to the second voltage rail and the third voltage rail and an inverter conductively coupled to the feedback loop and the third voltage rail.

Also disclosed herein is a method of manufacturing an integrated circuit, including forming a voltage translator over a substrate. The voltage translator is configured to receive a first voltage input and a second voltage input, and shift the second voltage input to a voltage output that is greater than the second voltage input. The method further includes forming a current source over the substrate. The current source is electrically coupled to the voltage translator. The current source supplies the voltage translator with a current that is independent of the first voltage input and the second voltage input.

The foregoing features and elements may be combined in any combination, without exclusivity, unless expressly indicated herein otherwise. These features and elements as well as the operation of the disclosed examples will become more apparent in light of the following description and accompanying drawings.

### BRIEF DESCRIPTION OF THE DRAWINGS

Reference will now be made to the accompanying drawings, which are not necessarily drawn to scale. While the drawings illustrate various examples employing the principles described herein, the drawings do not limit the scope of the claims.

FIG. 1 illustrates a functional diagram of a circuit, in accordance with various examples.

FIG. 2 illustrates a schematic diagram of a circuit in accordance with the functional diagram of FIG. 1 and in the various examples associated therewith.

FIG. 3 illustrates a schematic diagram of a circuit in accordance with the functional diagram of FIG. 1 and in the various examples associated therewith.

FIG. 4 illustrates graphs of circuit and voltage characteristics in accordance with the schematic diagrams of FIGS. 2 and 3 and the various examples associated therewith.

FIG. 5 illustrates a flowchart for a method of forming an integrated circuit in accordance with the schematic diagrams of FIGS. 2 and 3 and the various examples associated therewith.

### DETAILED DESCRIPTION

The following detailed description is presented for purposes of illustration and not of limitation. Benefits, advantages, and/or solutions to problems may be described with reference to various examples. The detailed description makes use of the various examples and refers to the accompanying drawings which illustrate the various examples described herein. The drawings, descriptions, and examples are described in sufficient detail to practice the disclosure. It is understood that connecting lines shown in the various drawings are intended to represent example functional relationships and/or physical couplings between various elements, but that other relationships and/or couplings are possible while remaining within the scope of the present disclosure. It will further be appreciated that the various drawings may not be drawn to scale in order to simplify and clarify the detailed description herein. Furthermore, it is understood that the descriptions and examples contained herein may permit the practice other examples using logical, chemical, and/or mechanical changes without departing from the spirit and scope of this disclosure. For example, the steps recited in method and process descriptions may be executed in a different order, additional process steps may be added, and/or process steps may be removed while remaining within the scope of the present disclosure.

Any reference to singular items and/or examples includes plural items and/or examples and any reference to more than one item and/or example may include a singular item and/or example. Similarly, references to “a”, “an”, or “the” may include one or more of the referenced items, unless stated otherwise. Any reference to connected, coupled, fixed, attached, or the similar words and/or phrases may include partial, full, temporary, removable, permanent, or the other connection options. Any reference to contact, or similar phrase, may include minimal contact or reduced contact. All ranges used herein may include both the upper and lower values of the ranges, including ratio limits, that are disclosed herein. Stated values may include at least the variation that is expected within the field in which the present disclosure is practiced and as would be understood and accepted to include values that are within 10% of a stated value. Similarly, the use of “approximately”, “about”, “substantially” or other similar term represents an amount that is close to the stated value and that may still achieve the stated, or desired, result and/or perform the stated, or desired, function and may refer to an amount that is within 10% of the stated value.

The accompanying drawings, and detailed description of the drawings, include reference numerals that may be repeated across multiple examples. The repetition of reference numerals is intended simplicity and clarity of description and is not intended to form or dictate a relationship between different examples described herein. The examples and descriptions provided herein are intended to be illustrative and not limiting beyond the scope of the claims. The use of terms such as “on” and “over” may indicate that a first feature is formed directly contacting a second feature or may indicate a relationship of the first feature and the second feature without direct contact between the two, such as additional features being formed between the two. For example, “on” may be used to indicate direct contact between the two and “over” may be used to indicate one or more intervening layers between the two.

Spatially relative terms such as, for example, “lower,” “upper,” “horizontal,” “vertical,” “above,” “over,” “below,” “beneath,” “up,” “down,” “top,” “bottom,” etc. as well as derivatives thereof (e.g., “horizontally,” “downwardly,” “upwardly,” etc.) are used for ease of discussion herein and are not intended to limit the orientation of the various components, systems, apparatuses, devices, or other features. It is therefore understood and appreciated that the use of the spatially relative terms to practice this disclosure in different orientations remains within the scope of the present disclosure.

Reference may be made throughout the present disclosure to various concepts such as voltage, temperature, time frames, and physical size, among others. It is understood that these design parameters, operating ranges and ranges of use associated with each of the mentioned concepts are intended to serve as examples without implied limitation. In various examples, reference may be made to normal, room temperature, and high temperatures, among others. These references are intended for purposes of description as temperature ranges that constitute high or normal may be specific to a design choice or intended application. The descriptions and examples included in the present disclosure may be adapted for the specific integrated circuit that is being designed while remaining within the scope of the present disclosure.

Disclosed herein is a compact and low power supply fail-safe (SFS) circuit. SFS circuits may be used in dual voltage circuits having a first operating voltage, a second operating voltage, and an output signal. In various examples, the first operating voltage is in a first voltage domain, such as a core logic circuit operating voltage, and the second operating voltage is in a second voltage domain, such as an I/O circuit operating voltage. In various examples, the first voltage domain may be a lower voltage domain (e.g., 1.8 V) and the second voltage domain may be a higher voltage domain (e.g., 3.3 V or 5 V). In various examples, the output signal may have a maximum value about equal to the second operating voltage, e.g., the voltage of the output signal may be higher than the lower voltage domain and have a maximum voltage about equal to the higher voltage domain. In various examples, a level shifter may be used to convert the voltage of the first operating voltage to a higher voltage so that the output signal is higher than the first operating voltage. In various examples, the first operating voltage may be floating or unavailable during power on when a first power supply that generates the first operating voltage lags a second power supply that generates the second operating voltage. This may result in the level shifter having a floating input leading to current leakage and/or an indefinite output signal. SFS circuits of the disclosure may address this issue by, in various examples, maintaining the output signal at a definite state even when the first power supply is floating or unavailable.

While in use, current consumption of SFS circuits can vary based on variations in the first power supply and/or the second power supply. In various examples, the current consumption may vary in response to changes in operating temperature and/or voltage. This current consumption can vary from a few nanoamperes (nA) to tens of microamperes (μA). Some baseline SFS circuits rely on large resistors to limit the current consumption of the SFS circuit. SFS circuits consistent with the disclosure reduce the current consumption while using less die area than such baseline SFS circuits. Furthermore, the current consumption of SFS circuits consistent with the disclosure are expected to be relatively independent of variation in the first operating voltage and the second operating voltage.

Disclosed herein, according to various examples, are improved SFS circuits that reduce the current consumption for a given die area and reduce variation of current consumption across voltage and temperature ranges. As described further below, example SFS circuits may use depletion mode NMOS transistors and back-to-back cross-coupled PMOS transistors to form a negative feedback loop. This negative feedback loop may consume similar, or less, current than baseline SFS circuits using about 25% of the die area used for otherwise analogous baseline circuits. In various examples, example SFS circuits consume about 60 μm²·μA as compared to a representative baseline SFS circuit that consumes about 280 μm²·μA. (Note that the dimension “μm²·μA” is a figure of merit (FOM) that may be used to compare power consumption of different SFS circuits.) This reduction is achieved, in various examples, by creating two parallel circuit branches, one having a first current (I1) and another having a second current (I2). This parallel branch design reduces the variation of the first current (I1) and the second current (I2) across process voltage and temperature variations, effectively reducing dependence of the total current of the SFS circuit on the operating voltage and one or both of the first and second operating voltages.

As described in further detail below, a first branch of the SFS circuit includes a first resistor, a first PMOS transistor, and a first NMOS transistor. The first resistor is conductively coupled to a first voltage rail configured to provide a voltage in the first voltage domain (e.g. an I/O voltage such as 3.3 V or 5 V), and to the source of the first PMOS transistor. The drain of the first PMOS transistor is conductively coupled to the drain of the first NMOS transistor. The source of the first NMOS transistor is conductively coupled to a reference voltage rail (e.g., ground). A first current I1 flows through the first branch of the SFS circuit, with the output signal being at an output node connecting the drain of the first PMOS transistor to the drain of the first NMOS transistor. The gate of the first NMOS transistor is conductively coupled to a second voltage rail configured to provide a voltage in the first voltage domain (e.g. a core logic voltage such as 1.8 V).

A second branch of the SFS circuit provides a path for a second current I2 between the first voltage rail and the reference rail parallel to the second branch. The second branch includes a second NMOS transistor, second and third PMOS transistors, and a second resistor. The source of the second PMOS transistor is conductively coupled to the first voltage rail, and the gate of the second PMOS transistor is conductively coupled to the source of the first PMOS transistor in the first branch. The drain of the second PMOS transistor is conductively coupled to the drain of the second NMOS transistor and to the gate of the first PMOS transistor. The source of the second NMOS transistor is conductively coupled a first terminal of the second resistor, and the gate of the second NMOS transistor is conductively coupled to a second terminal of the second resistor and to the source of the third PMOS transistor. The drain of the third PMOS transistor is conductively coupled to the reference voltage rail, and the gate of the third PMOS transistor is conductively coupled to the second voltage rail. The second NMOS transistor and the first and second PMOS transistors form the feedback loop to provide the first current I1 to the output node. In various examples, the feedback loop may additionally include the first resistor R1 and the second resistor R2.

While such examples may be expected to provide improvements in performance, such as reduced leakage, or quiescent current of an integrated circuit employing an SFS circuit, no particular result is a requirement of the present invention unless explicitly recited in a particular claim

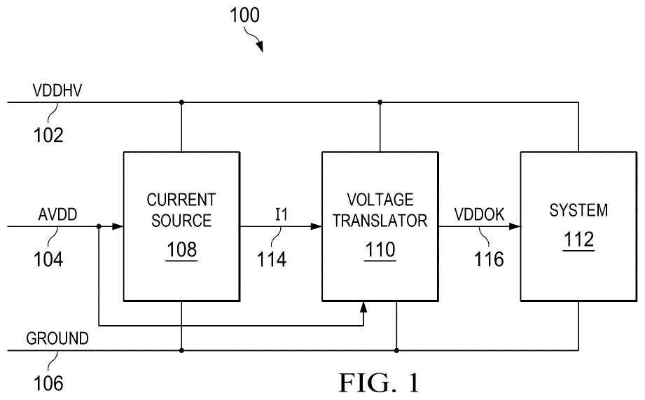

Referring now to FIG. 1, a functional diagram of a circuit 100 is illustrated, in accordance with various examples of the present disclosure. Circuit 100 includes a first voltage rail 102 (VDDHV), a second voltage rail 104 (AVDD), a third voltage rail 106 (GROUND), a current source 108, a voltage translator 110, a system 112, an output current 114, and an output signal 116 (VDDOK). As will be described in further detail below, current source 108 and voltage translator 110 are configured to cooperate to provide a voltage level shifter that translates an input signal at a lower voltage domain (e.g., AVDD at the at a core logic operating voltage on second voltage rail 104) to an output signal at a higher voltage domain (e.g., VDDOK at an I/O voltage on the output signal 116) for use by system 112. Current source 108 and voltage translator 110, operate together thereby keeping the output signal 116 at a definite state even when the input signal, e.g. AVDD, is floating or unavailable.

In various examples, first voltage rail 102 may be configured to provide a positive voltage, a negative voltage, or a ground reference. In various examples, first voltage rail 102 may be part of the second voltage domain (e.g., 3.3 V, 5 V, etc.). In various examples, second voltage rail 104 may be configured to provide a positive voltage, a negative voltage, or a ground reference. In various examples, second voltage rail 104 may be part of the first voltage domain (e.g., 1.8 V). In various examples, the second voltage domain may be a lower voltage than the first voltage domain. In various examples, third voltage rail 106 may be configured to provide a positive voltage, a negative voltage, or a ground reference. In various examples, third voltage rail 106 may be a ground reference for circuit 100, and may sometimes be referred to as ground rail 106. For ease of discussion and simplicity, first voltage rail 102 (e.g., the second voltage domain or VDDHV) will be referred to as having a higher voltage, second voltage rail 104 (e.g., the first voltage domain or AVDD) will be referred to as having a lower voltage than first voltage rail 102, and third voltage rail 106 (e.g., ground reference) will be referred to as having a lower voltage than second voltage rail 104, e.g. zero volts.

Current source 108 is conductively coupled to first voltage rail 102, second voltage rail 104, and third voltage rail 106. Current source 108 is configured to provide an output current 114 (I1) the presence of which is independent of the voltage of first voltage rail 102 and/or second voltage rail 104, (when the device is energized within normal operating ranges). For example, output current 114 is available based on the connection to first voltage rail 102 and second voltage rail 104. However, while the magnitude of output current 114 may be dependent on the voltage of first and/or second voltage rails 102, 104, the output current will be present at some value if at least one of first and/or second voltage rails 102, 104 is energized.

Voltage translator 110 is conductively coupled to first voltage rail 102, second voltage rail 104, third voltage rail 106, and current source 108. Voltage translator 110 is configured to provide an output signal 116 that switches between the voltage of the third voltage rail 106, e.g. ground, and a voltage in the second voltage domain (e.g., VDDHV). The voltage of output signal 116 mirrors the voltage of second voltage rail 104. For example, output signal 116 has a low voltage (e.g., 0 V) in response to second voltage rail 104 having a low voltage (e.g., 0 V). Further to the example, output signal 116 has a high voltage (e.g., 3.3 V, 5 V, etc.) in response to second voltage rail 104 having a high voltage (e.g., 1.8 V). Thus, voltage translator 110 may be viewed as shifting the voltage of second voltage rail 104 from the first voltage domain to the second voltage domain for output signal 116. Output current 114 helps to drive output signal 116 and maintain consistent current relatively independent of variation of first voltage rail 102 and/or second voltage rail 104 when one or both of voltage rails 102, 104 are operating within design limits.

System 112 is conductively coupled to first voltage rail 102, third voltage rail 106, and output signal 116. In various examples, system 112 may include a power management integrated circuit (PMIC), an analog multiplexer, a crosspoint switch, among others. In various examples, system 112 may be enabled in response to second voltage rail 104 powering on. In various examples, system 112, or the various components therein, may be damaged when an SFS circuit is not used. Accordingly, ensuring that output signal 116 is defined, and definite, may protect system 112 by way of protection circuitry within system 112 that is responsive to the state of the output signal 116. As will be described in greater detail below, voltage translator 110 provides output signal 116 in a definite state while using about one quarter (25%) of the area of some baseline SFS circuits while providing a current that is relatively independent of fluctuations, or variations, in either first voltage rail 102 or second voltage rail 104. In other words, circuit 100 uses less die area while providing output current 114 that is relatively independent of variations in first voltage rail 102 and second voltage rail 104.

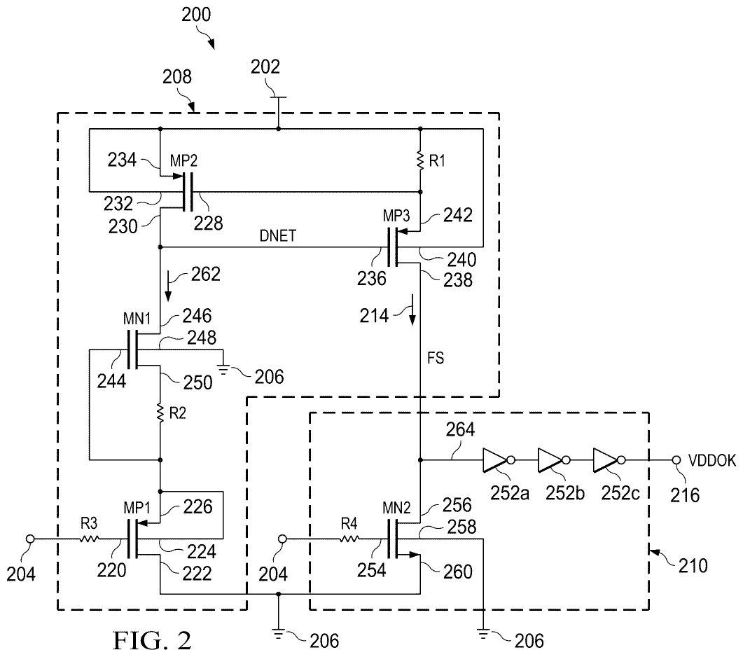

Referring now to FIG. 2 a schematic diagram of a circuit 200 is illustrated, in accordance with various examples of the present disclosure. Circuit 200 includes some analogous components to circuit 100 described above in FIG. 1, including a first voltage rail 202, a second voltage rail 204 and a third voltage rail 206. In various examples first voltage rail 202 is configured to provide a voltage in a higher voltage domain (e.g., 3.3 V or 5 V), second voltage rail 204 is configured to provide a voltage in a lower voltage domain (e.g., 1.8 V), and third voltage rail 206 is configured to provide a reference for first and second voltage rails 202, 204 (e.g. ground). For ease of description, and without implied limitation, first voltage rail 202 may be referred to as high-voltage (HV) rail 202, second voltage rail 204 may be referred to as low-voltage (LV) rail 204, and third voltage rail 206 may be referred to as ground rail 206. A current source 208 generates a first current 214 in a first circuit branch and a second current 262 in a parallel second circuit branch. A voltage translator 210 receives the first current 214 at a node that provides an unbuffered output signal that is inverted by a chain of inverting buffers 252a, 252b, 252c to produce an output signal 216. The inverting buffers 252a, 252b, 252c may be collectively referred to as inverting buffer 252. Circuit 200, in various examples, may be effective as a supply fail-safe (SFS) circuit whose current consumption is relatively insensitive to variation of voltages on the first and second voltage rails 202, 204. Additionally, circuit 200 is able to achieve such current consumption stability while using one quarter (25%) of the area of otherwise comparable baseline SFS circuit solutions. In other words, circuit 200 may use only about one fourth the die area needed by functionally analogous baseline SFS circuits while reducing current consumption and reducing sensitivity to power supply variation. It should be appreciated that the configuration of circuit 200 may vary from what is illustrated and described below while remaining within the scope of the present disclosure.

Current source 208 includes a first p-type transistor MP1 (sometimes referred to as first pull-down transistor MP1), a second p-type transistor MP2, a third p-type transistor MP3, a first n-type transistor MN1, a first resistor R1, a second resistor R2, and a third resistor R3, which are interconnected as shown. Voltage translator 210 includes a second n-type transistor MN2 (sometimes referred to as second pull-down transistor MN2), a fourth resistor R4, and inverting buffer 252. First resistor R1 may have a resistance in a range from about 700 kΩ to about 1,000 kΩ, and in some examples in a range from about 800 kΩ to about 900 kΩ. Second resistor R2 may have a resistance in a range from about 0.8 MΩ to about 1.2 MΩ, and in some examples in a range from about 0.9 MΩ to about 1.1 MΩ. Third resistor R3 may have a resistance in a range from about 0.8 kΩ to about 1.2 kΩ, and in some examples in range from about 0.9 kΩ to about 1.1 kΩ.

In various examples, transistors MP1, MP2, MP3, MN1, and/or MN2 may be one of a metal oxide semiconductor field effect transistor (MOSFET), a power MOSFET, an insulated-gate bipolar transistor (IGBT), a laterally diffused MOSFET (LDMOS), complimentary MOSFET (CMOS), drain extended MOSFET (DEMOS), or another transistor. As described herein transistors MP1, MP2, MP3, MN1, and/or MN2 are variously described as being either enhancement mode or depletion mode transistors. It should be appreciated that each of transistors MP1, MP2, MP3, MN1, MN2 be either enhancement mode or depletion mode transistors depending on the specific implementation of SFS circuits within the scope of the disclosure.

As illustrated in FIG. 2, and with respect to current source 208, a first terminal of first resistor R1 is conductively coupled to HV rail 202 and body terminal 240 of MP3, and a second terminal of first resistor R1 is conductively coupled to source terminal 242 of MP3 and gate terminal 228 of MP2. Body terminal 232 and source terminal 234 of MP2 are conductively coupled to HV rail 202. MP2 drain terminal 230 is conductively coupled to gate terminal 236 of MP3 and to drain terminal 246 of MN1 via circuit node DNET. Drain terminal 238 of MP3 is conductively coupled to input terminal 264 of inverting buffer 252a and to drain terminal 256 of MN2 via circuit node FS. The circuit node connecting drain terminal 238, drain terminal 256 and input terminal 264 may be referred to as an unbuffered output signal node.

Continuing with current source 208, body terminal 248 of MN1 is conductively coupled to ground rail 206, source terminal 250 is conductively coupled to a first terminal of second resistor R2, and gate terminal 244 is conductively coupled to a second terminal of second resistor R2, and source terminal 226 and body terminal 224 of MP1. Gate terminal 220 of MP1 is conductively coupled to LV rail 204 via resistor R3, and drain terminal 222 is conductively coupled to ground rail 206.

As illustrated in FIG. 2, and with respect to voltage translator 210, gate terminal 254 of MN2 is conductively connected to LV rail 204 via resistor R4, and body terminal 258 and source terminal 260 are conductively connected to ground rail 206. As described previously drain terminal 256 is conductively coupled to input terminal 264 of inverting buffer 252a via the unbuffered output signal node that includes drain terminal 238 of MP3. An output of inverting buffer 252a is conductively coupled to an input of inverting buffer 252b, an output of inverting buffer 252b is conductively coupled to an input of inverting buffer 252c, and inverting buffer 252c provides output signal 216 of the circuit 200.

With respect to current flow through the circuit 200, first current 214 flows from HV rail 202 through first resistor R1, transistor MP3 and transistor MN2 to ground rail 206. Second current 262 flows from HV rail 202 through transistor MP2, transistor MN1, second resistor R2, and transistor MP1 to ground rail 206. First current 214 (I1) may be determined using Equation 1:

$${I}_{1} = \frac{{V}_{g s ( M P 2 )}}{{R}_{1}} \qquad ( 1 )$$

In the Equation 1, first current 214 is equal to the gate-source voltage of second p-type transistor MP2 divided by the resistance of first resistor R1. In other words, first current 214 is inversely proportional to the resistance of first resistor R1. Second current 262 (I2) may be defined using Equation 2:

$${I}_{2} = \frac{{V}_{T H ( M N 1 )} - Δ {V}_{T H ( M {N}_{1} ) , Vsb}}{{R}_{2}} \qquad ( 2 )$$

In Equation 2, second current 262 is equal to the threshold voltage of first n-type transistor MN1 minus the change in threshold voltage due to the source-body voltage of transistor MN1, divided by the resistance of second resistor R2. In other words, second current 262 is inversely proportional to the resistance of second resistor R2. The current 262 may be modulated by the negative feedback of the first n-type transistor MN1, first p-type transistor MP1, second p-type transistor MP2, and third p-type transistor MP3.

Circuit 200, as previously mentioned, is a supply fail-safe (SFS) circuit for a dual supply system, e.g., a system having two different voltage rails in addition to a reference voltage rail such as ground. During power-up a first power supply (e.g., energizing first voltage rail 202 with an I/O voltage) and a second power supply (e.g., energizing second voltage rail 204 with a core logic voltage) may need time to power on and achieve operating voltage. In various examples, the second power supply may not stabilize at its predetermined operating voltage at the same time that the first power supply stabilizes at its predetermined operating voltage. Such a condition may cause the second power supply (e.g., second voltage rail 204) to provide a voltage for some components of an integrated circuit (e.g., system 112) that is undefined or indefinite. That is, the first power supply (e.g., first voltage rail 202) may provide power before the second power supply (e.g., second voltage rail 204) provides power which can result in the second power supply (e.g., second voltage rail 204) to components of the integrated circuit (e.g., system 112) being incorrect, ambiguous, or undetermined. This lag during power-up can, in various examples, cause damage to components of the integrated circuit (e.g., system 112). Accordingly, circuit 200 ensures that output signal 216 is at a known state, or voltage, during power-up of first voltage rail 202 and second voltage rail 204.

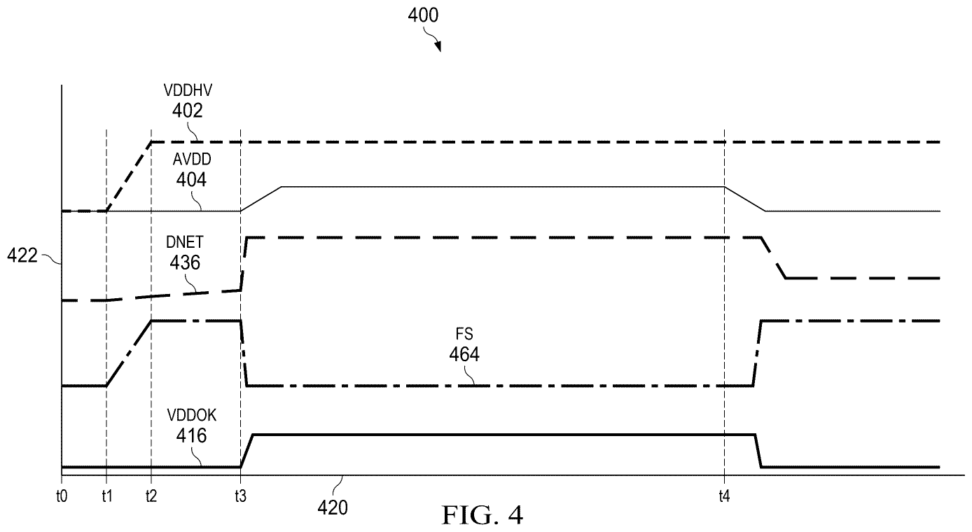

During operation of circuit 200, and as described in further detail below in FIG. 4, output signal 216 remains low (e.g., 0 V) until both first voltage rail 202 and second voltage rail 204 are greater than a threshold voltage. For example, output signal 216 is low in response to first voltage rail 202 and second voltage rail 204 being low. In other examples, output signal 216 is low in response to first voltage rail 202 being high (e.g., 3.3 V, 5 V) and second voltage rail 204 being low. In still other examples, output signal 216 is high (e.g., 3.3 V, 5 V) in response to first voltage rail 202 being high and second voltage rail 204 being high (e.g., 1.8 V). Also, in some examples, output signal 216 is low in response to first voltage rail 202 being low and second voltage rail 204 being high. Therefore, in various examples, the value of output signal 216 is known and not indefinite for all values of first voltage rail 202 and second voltage rail 204.

Accordingly, as described above, circuit 200 includes a negative feedback loop including first n-type transistor MN1, second p-type transistor MP2, third p-type transistor MP3, first resistor R1, and second resistor R2. The negative feedback loop decouples first current 214 from first voltage rail 202 resulting in less current variation in first current 214 in response to variations in first voltage rail 202. Additionally, the sizes of first resistor R1 and second resistor R2, in various examples, are smaller than baseline SFS circuits. This results in circuit 200 occupying about 25% of the die area used for an otherwise comparable baseline SFS circuit. Accordingly, as described herein circuit 200 provides improvements in SFS circuits for dual power supply systems.

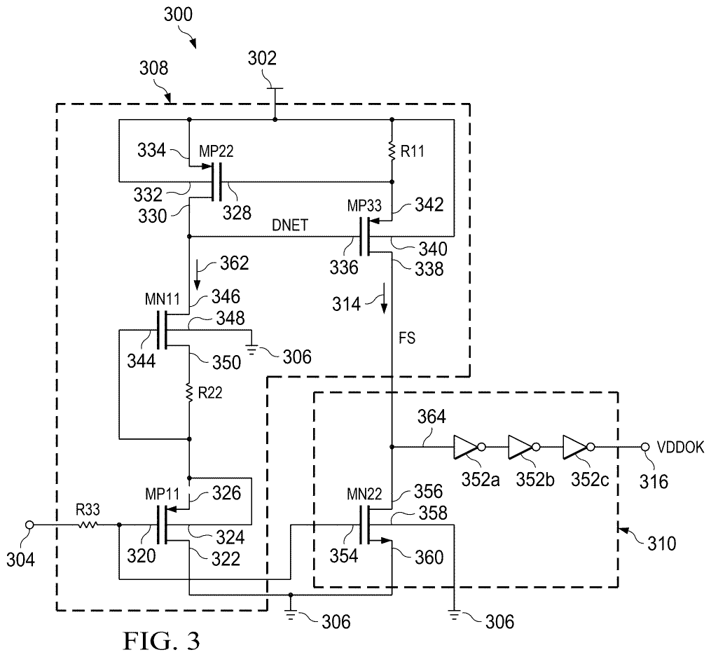

Referring now to FIG. 3, a schematic diagram of a circuit 300 is illustrated, in accordance with various examples of the present disclosure. Circuit 300 includes analogous components to circuit 200 described above in FIG. 2, including a first p-type transistor MP11, a second p-type transistor MP22, a third p-type transistor MP33, a first n-type transistor MN11, a second n-type transistor MN22, a first resistor R11, a second resistor R22, a third resistor R33, a first voltage rail 302, a second voltage rail 304, a third voltage rail 306, a current source 308, a voltage translator 310 including inverting buffers 352a-352c, a first current 314, a second current 362 and an output signal 316. Various device terminals are numbered in an analogous manner as FIG. 2., descriptions of which may not be repeated below.

Circuit 300, as shown in FIG. 3, shows gate terminal 354 of MN22 conductively coupled to the node connecting third resistor R33 to the gate 320 of transistor MP11. This configuration removes an additional resistor (e.g., fourth resistor R4) and additional power input (e.g., additional second voltage rail 304 connection) from the implementation of circuit 300. Removing the additional resistor reduces the die area used by circuit 300 as compared to circuit 200 as well as other supply fail-safe circuit implementations. Furthermore, this change has little to no effect on the function of circuit 300 as compared to circuit 200.

Referring now to FIG. 4, a timing diagram 400 for a supply fail-safe (SFS) circuit is illustrated, in accordance with various examples of the present disclosure. Timing diagram 400 is an illustration of the operation of circuit 200 described above with respect to FIG. 2 and is used for illustrative and description purposes without implied limitation. As such, it is understood that timing diagram 400 may not fully illustrate the subject electrical signals as they may occur in an actual device. Instead, timing diagram 400 illustrates the relative timing of the different events occurring in circuit 200 during startup of a dual power supply integrated circuit.

Timing diagram 400 has a horizontal axis 420 representing time and a vertical axis 422 that qualitatively reflects the magnitude of the subject device parameter, such as voltage or current. In various examples, timing diagram 400 may be representative of operations of circuit 200. A first voltage line 402 indicates the voltage of first voltage rail 202 (VDDHV), a second voltage line 404 indicates the voltage of second voltage rail 204 (AVDD), third voltage line 436 indicates the voltage at the DNET circuit node (including gate terminal 236 of transistor MP3), fourth voltage line 464 indicates the voltage at the FS node (including input terminal 264 to inverting buffer 252a), and fifth voltage line 416 indicates the voltage of the output signal 216, VDDOK. In various examples, timing diagram 400 may be representative of the operation of circuit 300 and its corresponding components.

At time t0, VDDHV and AVDD are 0 V and the SFS circuit (e.g., circuit 200, circuit 300) is inoperative. At time t1, the integrated circuit of which the SFS circuit is a component is powered on, and VDDHV ramps up to a predetermined operating voltage (e.g. consistent with I/O components operating at 3.3 V or 5 V) at time t2. AVDD (e.g., second voltage rail 204, second voltage rail 304) remains low due to, e.g., time lag, power-on delay, or reasons as sometimes occurs in device power-up. The voltage of the DNET node (e.g., gate terminal 236 of transistor MP3, gate terminal 336 of transistor MP33) begins to increase slightly in response to the increase of VDDHV. The voltage of the FS node (e.g., input terminal 264, input terminal 364) increases from ground to about VDDHV at t2 as transistor MP3 has high conductivity due to the low voltage of DNET. The output inverting buffer (e.g. inverting buffer 252) is energized by VDDHV but the VDDOK signal remains low due to the inversion of the FS node voltage.

At time t2, the VDDHV reaches a predetermined operating voltage and is at the high state (e.g., 3.3 V or 5 V). The voltage of second voltage line 404 remains low due to continued delay between the VDDHV and AVDD power-up. The DNET node continues to increase slightly in response to VDDHV. The voltage of the FS node remains high, and the VDDOK signal remains low.

At time t3, the AVDD voltage begins to increase from low to high (e.g., 1.8 V) after Δt=t3−t1. The voltage of the DNET node increases from low to high (e.g., 4.5 V) in response to the increasing voltage of AVDD, which turns off the first pull-down transistor MP1. The voltage of the FS node transitions from high to low (e.g. ground) in response to the increase of AVDD which turns on the second pull-down transistor, e.g. MN2. VDDOK transitions from low to high (e.g., 3.3 V or 5 V) by inverting the FS voltage. Various parts of the system powered by VDDHV and AVDD may include circuitry to disable operation before VDDOK indicates both VDDHV and AVDD are active, and at this point that any attached circuits (e.g., system 112) may initiate intended operation.

Time t4 represents a time at which AVDD transitions from high to low, e.g. during a power-down sequence or failure of an AVDD power supply. VDDHV remains high, though may later also transition from high to low. The voltage of the DNET node transitions from high to low, possibly with a time lag, as AVDD is de-energized, and the FS node from low to high as the second pull-down transistor, e.g. MN2, transitions to a high-impedance state. In response, VDDOK transitions from high to low by inverting the state of the FS node.

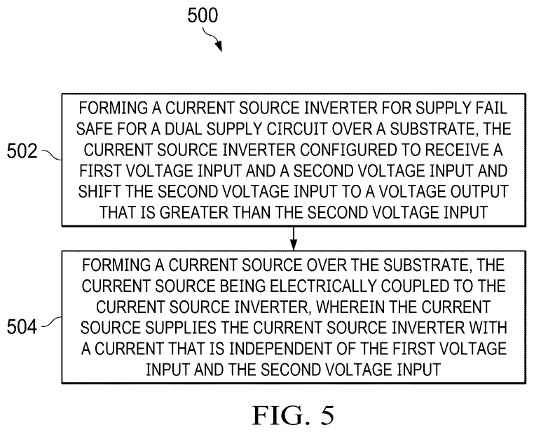

Referring now to FIG. 5, a flow diagram of a method 500 for forming a supply fail-safe (SFS) circuit, including a current source circuit and a voltage translator circuit, is illustrated, in accordance with various examples of the present disclosure. In various examples, method 500 may be used to form circuit 200 and/or circuit 300. At step 502, a voltage translator for supply fail-safe for a dual supply circuit is formed over a substrate. The voltage translator is configured to receive a first voltage input and a second voltage input and shift the second voltage input to a voltage output that is greater than the second voltage input. At step 504, a current source is formed over the substrate. The current source is electrically coupled to the voltage translator and the current source supplies the voltage translator with a current that is independent of the first voltage input and the second voltage input.

Accordingly, the circuits and methods disclosed herein provide a supply fail-safe (SFS) for a dual power supply circuit, including a current source and a voltage translator, for providing an output voltage that is at a defined state regardless of the state of one or both dual power supplies. In various examples disclosed herein, the SFS circuit provides a level shifted output voltage based on one of the power supplies. In various examples disclosed herein, the current driving the output voltage of the SFS circuit is decoupled from variations in one or both power supplies caused by variations in temperature and/or voltage. In various examples, the area used by the SFS circuit disclosed herein is about four times smaller than comparable traditional SFS circuits.

Finally, it should be understood that any of the above-described concepts can be used alone or in combination with any or all of the other above-described concepts. Although various examples have been disclosed and described, it is understood, recognized, and/or contemplated that certain modifications would come within the scope of this disclosure. Accordingly, the description is not intended to be exhaustive or to limit the principles described or illustrated herein to any precise form. Many modifications and variations are possible in light of the above teaching.

What is claimed is:

1. A device, comprising:
a first voltage rail;
a second voltage rail configured to provide a first voltage;
a current source component conductively coupled to the first voltage rail and the second voltage rail, the current source component configured to provide a first current; and
a voltage translator conductively coupled to the second voltage rail and the current source component, the voltage translator configured to invert the first voltage to a second voltage and provide an output signal including the first current and the second voltage.

2. The device of claim 1, wherein the current source component includes a current feedback circuit.

3. The device of claim 2, wherein the current feedback circuit includes:
a first n-type transistor having a first gate terminal, a first drain terminal, and a first source terminal;
a first resistor conductively coupled between the first gate terminal and the first source terminal;
a first p-type transistor having a second gate terminal, a second drain terminal, and a second source terminal, the second drain terminal conductively coupled to the first drain terminal and the second source terminal conductively coupled to the first voltage rail; and
a second p-type transistor having a third gate terminal, a third drain terminal, and a third source terminal, the third gate terminal conductively coupled to the second drain terminal, the third source terminal conductively coupled to the second gate terminal, and the third drain terminal conductively coupled to the voltage translator.

4. The device of claim 3, wherein the first n-type transistor is a depletion mode n-type transistor.

5. The device of claim 3, wherein the current source component further includes:
a second resistor conductively coupled between the third source terminal and the first voltage rail; and
a third p-type transistor having a fourth gate terminal, a fourth drain terminal, and a fourth source terminal, the fourth gate terminal conductively coupled to the second voltage rail, the fourth source terminal conductively coupled to the first resistor and the first gate terminal, and the fourth drain terminal conductively coupled to a third voltage rail.

6. The device of claim 5, wherein the first resistor has a resistance of about 0.8 MΩ to about 1.2 MΩ and the second resistor has a resistance of about 700 kΩ and about 1,000 kΩ.

7. The device of claim 1, further comprising:
a plurality of inverters conductively coupled to the output signal.

8. A device, comprising:
a first voltage rail;
a second voltage rail;
a third voltage rail; and
a supply fail-safe component conductively coupled to the first voltage rail, the second voltage rail, and the third voltage rail, the supply fail-safe component configured to provide an output signal based on a voltage of the first voltage rail, the supply fail-safe component including:
a feedback loop conductively coupled to the second voltage rail and the third voltage rail; and
an inverter conductively coupled to the feedback loop and the third voltage rail.

9. The device of claim 8, wherein the feedback loop includes:
a first n-type transistor having a first gate terminal, a first drain terminal, and a first source terminal;
a first resistor conductively coupled between the first gate terminal and the first source terminal;
a first p-type transistor having a second gate terminal, a second drain terminal, and a second source terminal, the second drain terminal conductively coupled to the first drain terminal and the second source terminal conductively coupled to the second voltage rail; and
a second p-type transistor having a third gate terminal, a third drain terminal, and a third source terminal, the third gate terminal conductively coupled to the second drain terminal, the third source terminal conductively coupled to the second gate terminal, and the third drain terminal conductively coupled to the inverter.

10. The device of claim 9, wherein the first p-type transistor further includes a body terminal, the body terminal conductively coupled to the second voltage rail.

11. The device of claim 9, further comprising:
a second resistor conductively coupled between the second voltage rail and the third source terminal; and
a third p-type transistor having a fourth gate terminal, a fourth drain terminal, and a fourth source terminal, the fourth gate terminal conductively coupled to the first voltage rail, the fourth source terminal conductively coupled to the first resistor and the first gate terminal, and the fourth drain terminal conductively coupled to the third voltage rail.

12. The device of claim 11, wherein the second p-type transistor further includes a body terminal, the body terminal conductively coupled to the fourth source terminal.

13. The device of claim 8, wherein the inverter includes:
a first n-type transistor having a first gate terminal, a first drain terminal, and a first source terminal, the first gate terminal conductively coupled to the first voltage rail and the first source terminal conductively coupled to the third voltage rail; and
a first p-type transistor having a second gate terminal, a second drain terminal, and a second source terminal, the second gate terminal conductively coupled to the feedback loop, the second source terminal conductively coupled to the second voltage rail, and the second drain terminal conductively coupled to the first drain terminal.

14. The device of claim 13, wherein the supply fail-safe component further includes:
an inverter having an input and an output, the input conductively coupled to the first drain terminal and the second drain terminal, wherein the output provides the output signal.

15. The device of claim 8, wherein the first voltage rail is configured to operate at a first voltage and the second voltage rail is configured to operate a second voltage that is different than the first voltage.

16. The device of claim 15, wherein the output signal provides a third voltage that is between the first voltage and the second voltage.

17. A method of manufacturing an integrated circuit, comprising:
forming a voltage translator for supply fail-safe for a dual supply circuit over a substrate, the voltage translator configured to receive a first voltage input and a second voltage input and shift the second voltage input to a voltage output that is greater than the second voltage input; and
forming a current source over the substrate, the current source being electrically coupled to the voltage translator, wherein the current source supplies the voltage translator with a current that is independent of the first voltage input and the second voltage input.

18. The method of claim 17, wherein forming the current source further includes:
forming a first p-type transistor having a first gate terminal, a first source terminal, and a first drain terminal;
forming a second p-type transistor having a second gate terminal, a second source terminal, and a second drain terminal;
forming a first conductive coupling between the first gate terminal, the second source terminal, and the first voltage input;
forming a second conductive coupling between the first source terminal and the first voltage input; and
forming a third conductive coupling between the second gate terminal and the first drain terminal.

19. The method of claim 18, wherein forming the current source further includes:
forming a first n-type transistor having a third gate terminal, a third source terminal, and a third drain terminal;
forming a first resistor conductively coupled to the third source terminal; and
forming a fourth conductive coupling between the third gate terminal and the first resistor,
wherein forming the third conductive coupling further includes forming the third conductive coupling between the second gate terminal, the first drain terminal, and the third drain terminal.

20. The method of claim 18, wherein forming the voltage translator includes:
forming a first n-type transistor having a third drain terminal; and
forming a fourth conductive coupling between the third drain terminal and the second drain terminal.
